(19) United States
(12) Patent Application Publication
(10) Pub. No.: US 2014/0102629 A1
(43) Pub. Date: Apr. 17, 2014

(54) Applique System with Anti-Corrosion Adhesive

(71) Applicant: Lockheed Martin Corporation, Bethesda, MD (US)

(72) Inventors: Jacob A. Johnson, Bethesda, MD (US); Jefre H. Cockerham, Fort Worth, TX (US); James R. Reed, Azle, TX (US); William J. Betush, Chandler, AZ (US); William F. Campbell, Fort Worth, TX (US)

(73) Assignee: Lockheed Martin Corporation, Bethesda, MD (US)

(21) Appl. No.: 14/070,010

(22) Filed: Nov. 1, 2013

Related U.S. Application Data
(62) Division of application No. 11/508,704, filed on Aug. 23, 2006, now abandoned.

(51) Int. Cl. C09D 5/08

(52) U.S. Cl. CPC C09D 5/086
USPC 156/230; 156/326; 156/278

(57) ABSTRACT

An appliqué having anti-corrosive adhesive is provided by embodiments of the present invention. This appliqué includes a thin polymer film and a pressure sensitive adhesive. The pressure sensitive adhesive hacks the thin polymer film and includes corrosion-inhibiting additives. These corrosion-inhibiting additives reduce or eliminate the need for a chromated primer layer beneath the appliqué. Elimination of a chromated primer layer has environmental advantages as well as cost benefits through the elimination of a processing step. Additionally, environmental benefits are realized by eliminating the toxic effects often associated with the use of chromated primers.

### CROSS-REFERENCE TO RELATED APPLICATION

This application is a divisional of Ser. No. 11/508,704, filed Aug. 23, 2006.

### TECHNICAL FIELD OF THE INVENTION

The present invention relates generally to coating surfaces and more particularly, a system and method applying coatings while inhibiting corrosion.

### BACKGROUND OF THE INVENTION

Paint can serve to protect the outer surface as well as to provide decorative features. Paint is applied in a controlled environment to alleviate environmental and health hazards, which results in significantly high costs. Current paint technology uses large volumes of volatile organic compounds for application and removal, such as methylene chloride and methyl ethyl ketone, and heavy metals, such as chromium. Such materials are potentially hazardous to workers and the environment. As a result, there is a desire to eliminate the need to paint aircraft.

Vehicle or structure coating systems perform a number of functions including corrosion prevention, erosion control, marking, camouflage, electromagnetic shielding, and other special functions. The application of paint and solvents typically used to coat vehicles such as aircraft, cars, boats or other structures often involve the use of toxic paint and solvents in order to protect the surfaces and inhibit corrosion. These processes are not necessarily friendly to the environment.

One solution has been to replace paint with materials known as appliqués. Appliqués are thin polymer films backed by pressure sensitive adhesives. The use of appliqué as a paint substitute may provide substantial cost savings. However, the benefits are not purely economic. The implementation of an appliqué may enable the reduction of the level of hazardous material generated. Further benefits of appliqués are the reduction of painting requirements, reduction in repair time compared to touch up painting and the ability to perform appliqué repair concurrent with other aircraft maintenance.

The use of appliqués is aimed at greatly reducing the cost of servicing these coatings. Painting/stripping/repainting contributes significantly to maintenance and environmental costs. For example up to 90 percent of all hazardous materials associated with the upkeep of a vehicle such as an aircraft may stem from the paint/strip/repaint process. Additionally when repeated coatings are applied to a vehicle these coatings may add significant weight to the craft. For example a tactical aircraft may carry as much as 800 pounds of paint that accumulate and grow from repeated repainting of the aircraft. Such increases in weight can seriously degrade the performance of the vehicle.

The uses of appliqués offer significant advantages when applied to vehicles or structures. The costs associated with maintaining the surfaces may be reduced and the environmental or toxic effects of working and protecting these surfaces may also be reduced. However existing appliqué systems often require the use of a chromated primer layer beneath the appliqué in order to prevent corrosion. Therefore current appliqués may not necessarily eliminate all painting associated with maintaining a surface.

Appliqués have been used to protect substrates as an alternative to paint systems. For example, polyurethane appliqués have been used to protect aircraft leading edge substrates from damage from rain, sand, sleet, and other airborne particle damage. Cushioned versions of polyurethane appliqués have been used to absorb the impact energy of small rocks and debris and provide protection for antennas, fuselage panels, and composite wing flaps. Thin film appliqués capable of being printed with graphics have been used for aircraft markings and decals.

Surface preparation is of major importance. Current appliqués require that the primer be completely cured, properly sanded and cleaned prior to appliqué installation to prevent corrosion.

### SUMMARY OF THE INVENTION

Embodiments of the present invention provide an appliqué having anti-corrosion adhesives that substantially addresses the above-identified needs. More specifically embodiments of the present invention provide an appliqué having anti-corrosive adhesives. The appliqué includes a thin polymer film or backing and a pressure sensitive adhesive. The pressure sensitive adhesive backs the thin polymer layer and includes corrosion inhibiting additives. These corrosion inhibiting additives may be chromium or non-chromium based additives. The corrosion inhibiting additives reduce or eliminate the need for a chromated primer layer beneath the appliqué. Elimination of a primer layer has environmental advantages as well as cost benefits through the elimination of processing steps. Environmental benefits are realized by eliminating the toxic affects often associated with the use of chromated primers and greatly reducing the toxic effects associated with painting/stripping/and repainting.

Other embodiments of the appliqué of the present invention may further include a protective layer on both the backing and/or the adhesive. These protective layers may protect the thin polymer film or backing prior to placement on the surface or substrate. A release liner on the adhesive may prevent damage to the adhesive prior to application to the substrate as well. The backing, a thin polymer layer, may be made of polyurethane, polyester, or polyimid. Additionally this thin polymer layer film may include additives such as but not limited to plasticizers, extenders, antioxidants, ultraviolet light stabilizers, dyes, pigments, colorants, emissivity agents, fiber reinforcement, or other like additives known to those having skill in the art. The adhesive may be a heat, thermal, or photo curable adhesive. This appliqué may be placed on the surface of a vehicle such as an aircraft.

Another embodiment of the present invention provides a method of protection of the substrate. This includes the placement of an appliqué on a substrate. This appliqué includes a thin polymer layer or film and a pressure sensitive adhesive as discussed above. Additionally this method may further involve the removal of a protective liner prior to adhering the pressure sensitive adhesive to the substrate and the removal of a transfer paper or other protective layer from the outer surface of the backing.

Another embodiment provides an appliqué having enhanced corrosion protection capabilities. This appliqué includes a thin polymer film or backing wherein the outer surface may be protected with a transfer paper adhered to the outer surface of the thin polymer layer while the inner surface. The inner surface of the thin polymer layer or backing may be coupled to a layer of pressure sensitive adhesive having corrosion inhibiting additives.

### BRIEF DESCRIPTION OF THE DRAWINGS

For a more complete understanding of the present invention and the advantages thereof, reference is now made to the following description taken in conjunction with the accompanying drawings in which like reference numerals indicate like features and wherein:

FIG. 1 provides a cross sectional view of an appliqué having an adhesive layer that includes corrosion inhibiting additives in accordance with embodiments of the present invention; and

FIG. 2 provides a logic flow diagram in accordance with an embodiment of the present invention that describes a method of protecting a substrate with an appliqué having corrosion inhibiting additives.

### DETAILED DESCRIPTION OF THE INVENTION

Preferred embodiments of the present invention are illustrated in the figures like numerals being used to refer to like and corresponding parts of the various drawings.

Embodiments of the present invention are directed to appliqués, particularly appliqués that replace paint on substrates. Such appliqués are useful on vehicles, such as planes, trains, and automobiles, boats, and ships. Typically appliqués have been used on painted, primed (e.g., epoxy primer, chromated primer), or bare surfaces. The appliqués of the present invention reduce or eliminate the need to paint or prime the surface. This is achieved in part by incorporating corrosion inhibitors within the adhesive layers of the appliqué. The appliqués can be used on metal surfaces, particularly aluminum surfaces, and composite materials, such as carbon fiber reinforced composites.

The appliqués provided by embodiments of the present invention can be in a variety of shapes, sizes, and thicknesses. These appliqués can be in the form of sheet materials or in the form of three-dimensional shaped articles, such as a thermal-formed boot. Such three-dimensional shaped appliqués can be used on the wingtip or nose of an airplane, for example. If in the form of a sheet material, the appliqué typically has a thickness of about 3-760 micrometers, whereas if in the form of a three-dimensional object, the appliqué typically has a thickness of about 10-760 micrometers.

These appliqués can be used as decals and decorative appliqués or they as protective appliqués to reduce corrosion, gouge, and scratch damage, for example. These appliqués can be used in multiple layers, such as a protective appliqué over a decal or a decal over a protective appliqué, for example. Significantly, the appliqués of the present invention can be used to completely cover the exterior surface of a vehicle, such as an airplane, as a replacement for paint, as a protective coating over paint, or as a coating under paint

Appliqués of the present invention may exhibit a glossy appearance, hard, conformable surface that is stable under a wide variety of environmental conditions, including wide ranges of temperature and humidity, fluid-resistant, and adheres well to a variety of surfaces under a variety of conditions. A “conformable” appliqué can be applied to various contoured and/or complex surfaces and maintains intimate contact with the entire surface.

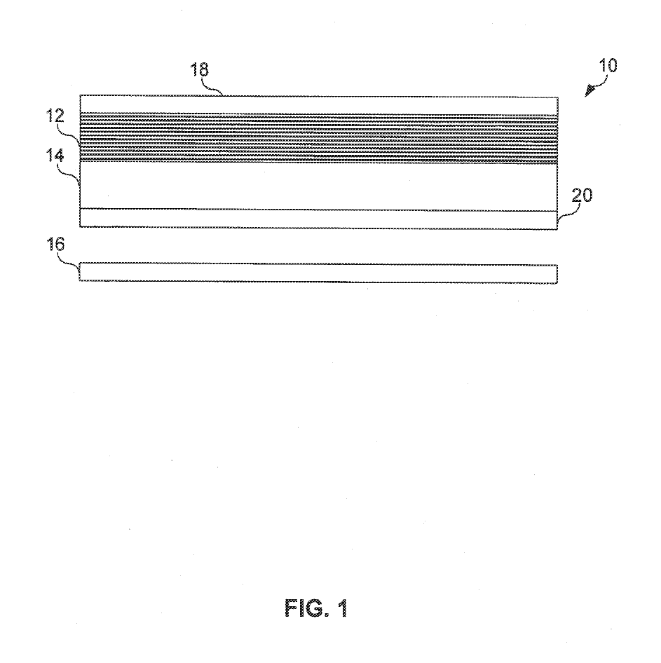

FIG. 1 depicts an appliqué in accordance with one embodiment of the present invention. Appliqué 10 includes a backing layer 12 (thin film polymer) having at least the lower surface treated with an adhesive layer 14. Adhesive layer 14 may be a pressure-sensitive adhesive (PSA) layer that incorporates a variety of corrosion inhibiting additives. These corrosion inhibiting additives may included, but are not limited to, hexamine, phenylenediamine, dimethylethanolamine, sodium nitrite, cinnamaldehyde, chromates, nitrates, zinc oxide, phosphates, morpholine, saturated carboxylated amines such as VPPI 2801, (a mixture of 10% by weight saturated carboxylated amines and 90% by weight isopropanol) manufactured by Vapor Phase Products Incorporated, and alkylammonium salt in xylene, such as IGRACOR 153 (a mixture of between 50-80% by weight alkylammonium salt and between 20-50% by weight xylenes) available from CIBA. Upper layer 10 may be a urethane coating layer on a fluorinated polymer. The pressure-sensitive adhesive may include an acryl ate copolymer such as a cross linked acryl ate copolymer. Significantly, appliqués of the present invention can withstand the harsh environments to which aircraft and other vehicles and structures are exposed while retaining high gloss, preventing gouge and scratch damage, and remaining conformable and removable. This allows the appliqué of the present invention to be used on the entire surface of an aircraft. Additionally a protective layer 18 and liner 20 may be used to protect the appliqué prior to placement on substrate 16.

Backing 10 (the upper layer or thin polymer film may include one or more fluorinated polymers. Herein, a polymer includes homopolymers and copolymers. Copolymers include polymers containing two or more different monomers, including terpolymers, tetrapolymers, etc. Fluorinated polymers suitable for use in making backings for appliqués of the present invention are those that form conformable, fluid-resistant sheet materials. As used herein, a “conformable” backing is one that can be applied to various contoured and/or complex surfaces and maintain intimate contact with the entire surface.

The backing 12 is typically in the form of sheet materials having two major surfaces. Typically, both of the surfaces are treated to allow for bonding of the adhesive and urethane layer. Backing 10 may be clear and colorless, or include a colorant, such as a pigment or dye. The pigment may be incorporated into one or more non-fluorinated polymers, which can be blended with one or more fluorinated polymers.

The backing adheres or bonds to a substrate using adhesives such as room temperature pressure-sensitive adhesives (PSA), hot melt PSAs, or thermoplastics that include corrosion inhibiting additives. The adhesive may be a room temperature PSA, such as but not limited to an acryl ate pressure-sensitive adhesive. Such materials possess a four-fold balance of adhesion, cohesion, stretchiness, and elasticity, and a glass transition temperature (Tg) of less than about 20° C.). Thus, the PSA can easily form a useful adhesive bond with the application of light pressure.

Acryl ate pressure-sensitive adhesives that incorporate corrosion inhibiting additives can be synthesized by a variety of processes, including solution, radiation, bulk, dispersion, emulsion, and suspension polymerization processes. Polymerization of the monomers to form the copolymer useful in the pressure-sensitive adhesive composition is typically carried out using thermal energy, electron-beam radiation, ultraviolet radiation, and the like. Such polymerizations can be facilitated by a polymerization initiator, which can be a thermal initiator or a photo initiator.

A pressure-sensitive adhesive 14 may be applied to the backing 10 by a variety of coating methods including knife coating, slotted knife coating, or reverse roll coating. If the composition includes a solvent, it is then dried at a temperature (e.g., about 65° C. to about 120° C.) and a time (e.g., several minutes to about one hour) so as to provide an adhesive appliqué. The thickness of the layer of adhesive may vary over a broad range of about 10 micrometers to several hundred micrometers (e.g., about 200 micrometers).

Once the adhesive composition has been substantially cured and optionally cross linked so as to provide an appliqué, the adhesive surface of the appliqué may, optionally, be protected with a temporary, removable release liner 20 (i.e., protective liner) such as a paper liner or plastic films such as polyolefin (e.g., polyethylene or polypropylene) or polyester (e.g., polyethylene terephthalate) film. Such paper or films may be treated with a release material such as silicones, waxes, fluorocarbons, and the like. Only after the adhesive composition has been substantially fully cured and optionally cross linked such that there is substantially no unsaturation are the adhesive appliqués of the present invention applied to a substrate.

The acrylate pressure-sensitive adhesive compositions can include conventional additives such as but not limited to corrosion inhibitors, hexamine, phenylenediamine, dimethylethanolamine, sodium nitrite, cinnamaldehyde, chromates, nitrates, zinc oxide, phosphates, morpholine, saturated carboxylated amines such as VPPI 2801 (a mixture of 10% by weight saturated carboxylated amines and 90% by weight isopropanol) manufactured by Vapor Phase Products Incorporated, and alkylammonium salt in xylene, such as IGRACOR 153 (a mixture of between 50-80% by weight alkylammonium salt and between 20-50% by weight xylenes) available from CIBA, tackifiers, plasticizers, flow modifiers, neutralizing agents, stabilizers, antioxidants, fillers, colorants, and the like. Such additives can be used in various combinations. If used, they are incorporated in amounts that do not materially adversely affect the desired properties of the pressure-sensitive adhesives or their fiber-forming properties. Typically, these additives can be incorporated into these systems in amounts of about 0.05 weight percent to about 25 weight percent, based on the total weight of the pressure-sensitive adhesive composition.

Appliqués of the present invention can be prepared using standard film-forming and adhesive-coating techniques. Typically, a fluoropolymer is extruded onto a carrier, such as polyethylene terephthalate film to form backing 12. The backing is then allowed to cool and solidify. The exposed surface of the backing is then treated to enhance adhesion of a pressure-sensitive adhesive layer 14. A layer of pressure-sensitive adhesive 14 is then applied to the treated surface of the backing. A wide variety of coating techniques can be used, such as knife coating, roll coating, fluid bearing die, etc. The adhesive can also be applied using solvent cast techniques, for example. Alternatively, a layer of adhesive could be laminated to the backing. Thus, the adhesive can be polymerized first and then applied to the backing or it can be applied as a prepolymer and cured while on the backing, A release liner 20 can be applied over the adhesive layer as described above. In some processes, it may be desirable to cure the adhesive through the release liner. The carrier for the backing is removed, and the exposed surface of the backing may be protected with a paper liner 18 as well. The outer exposed surface of the appliqué may be provided with a patterned structure. Such patterned structures are useful for reducing fluid (e.g., air, water) drag resistance over and/or across the exposed surface. For example, a polymeric sheet (also referred to as a liner) having an embossed structured pattern on one surface may be laminated to the exposed surface of an appliqué having thereon a not yet cured urethane coating layer such that the urethane coating is in contact with the structured pattern. The urethane coating layer is subsequently cured with the liner in place, followed by removal of the liner prior to use of the appliqué. The result is an appliqué with a cured outer layer of polyurethane whose exposed surface contains the reverse image of the embossed structured pattern of the liner.

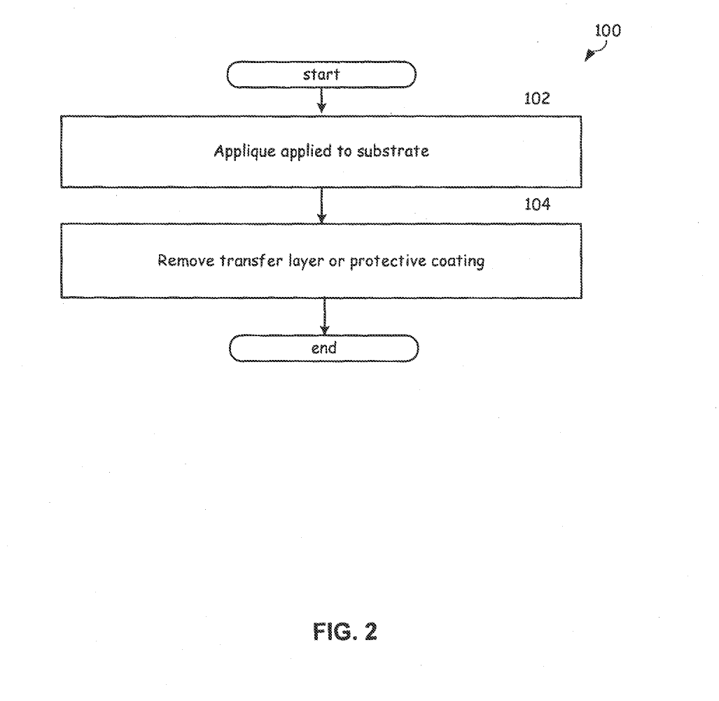

FIG. 2 provides a method of protecting a substrate that includes Operations 100. Operations 100 begin in Step 102 wherein an appliqué may be adhered to a substrate. This appliqué includes a backing or thin polymer film and a pressure sensitive adhesive as discussed previously. After the placement of the appliqué on the substrate a protective outer layer or transfer paper may be removed in Step 104 from the outer surface of the thin polymer film.

In summary, embodiments of the present invention provide an appliqué. This appliqué includes a thin polymer film and a pressure sensitive adhesive. The pressure sensitive adhesive backs the thin polymer film and includes corrosion-inhibiting additives. These corrosion-inhibiting additives reduce or eliminate the need for a chromated primer layer beneath the appliqué. Elimination of a chromated primer layer has environmental advantages as well as cost benefits through the elimination of a processing step. Additionally, environmental benefits are realized by eliminating the toxic effects often associated with the use of chromated primers.

Embodiments of the present invention provide an alternative for applying a coating precisely on a surface. Additionally, these embodiments provide a means to address the ever more stringent environmental restrictions that make it more challenging to apply coatings by conventional processes like spray painting because of the volatile solvents and hazardous pigments.

As one of average skill in the art will appreciate, the term “substantially” or “approximately”, as may be used herein, provides an industry-accepted tolerance to its corresponding term. Such an industry-accepted tolerance ranges from less than one percent to twenty percent and corresponds to, but is not limited to, component values, integrated circuit process variations, temperature variations, rise and fall times, and/or thermal noise. As one of average skill in the art will further appreciate, the term “operably coupled”, as may be used herein, includes direct coupling and indirect coupling via another component, element, circuit, or module where, for indirect coupling, the intervening component, element, circuit, or module does not modify the information of a signal but may adjust its current level, voltage level, and/or power level. As one of average skill in the art will also appreciate, inferred coupling (i.e., where one element is coupled to another element by inference) includes direct and indirect coupling between two elements in the same manner as “operably coupled”. As one of average skill in the art will further appreciate, the term “compares favorably”, as may be used herein, indicates that a comparison between two or more elements, items, signals, etc., provides a desired relationship. For example, when the desired relationship is that signal 1 has a greater magnitude than signal 2, a favorable comparison may be achieved when the magnitude of signal 1 is greater than that of signal 2 or when the magnitude of signal 2 is less than that of signal 1.

Although the present invention has been described in detail herein with reference to the illustrative embodiments, it should be understood that the description is by way of example only and is not to be construed in a limiting sense. It is to be further understood, therefore, that numerous changes in the details of the embodiments of this invention and additional embodiments of this invention will be apparent to, and may be made by, persons of ordinary skill in the art having reference to this description. It is contemplated that all such changes and additional embodiments are within the spirit and true scope of this invention as claimed below.

What is claimed is:

1. A method of protecting an outer surface portion of a vehicle, the outer surface portion being formed of aluminum or carbon fiber composite and being free of a chromated primer coating, comprising:
providing an appliqué comprising:
a polymer film selected from the group consisting of polyurethane, polyethylene, polyester, or polyimide; and
a pressure sensitive adhesive backing the polymer film, wherein the pressure sensitive adhesive comprises a corrosion inhibiting additive selected from the group consisting of hexamine, phenylenediamine, dimethylethanolamine, sodium nitrite, cinnamaldehyde, nitrates, phosphates, morpholine, a material comprising approximately 20-50% by weight xylene and 50-80% by weight alkylammonium salt, and a material comprising approximately 90% by weight isopropanol and 10% by weight saturated carboxylated amines; and
adhering the applique to the outer surface portion of the vehicle with the pressure sensitive adhesive in direct contact with the outer surface portion.

2. The method of claim 1, wherein the corrosion inhibiting additive is free of chromium.

3. The method of claim 1, wherein providing the polymer film further comprises applying a cured urethane coating layer to the polymer film.

4. The method of claim 3, further comprising providing an embossed structured pattern on the cured urethane coating layer.

5. The method of claim 1, further comprising heat curing the pressure sensitive adhesive.

6. The method of claim 1, wherein providing the polymer film further comprises including in the polymer film at least one additive selected from the group consisting of plasticizers, extenders, antioxidants, ultraviolet light stabilizers, des, pigments, emissivity agents, and fiber reinforcement.

7. The method of claim 1, further comprising:
removing a transfer paper from the thin polymer film, the paper being adhered to at least one face of the thin polymer film.

8. The method of claim 1, wherein providing the polymer film further comprises including an effective amount of at least one additive selected from the group consisting of:
plasticizers,
extenders,
antoxidants,
ultraviolet light stabilizers,
dyes,
pigments,
emissivity agents, and
fiber reinforcement.

9. A method of protecting an outer surface portion of a vehicle, the outer surface portion being formed of aluminum or carbon fiber composite and being free of any chromated primer coating, comprising:
providing a polymer film selected from the group consisting of polyurethane, polyethylene, polyester, or polyimide;
coating and curing on an outer surface of the polymer film a polyurethane coating layer;
applying a pressure sensitive adhesive to an inner surface of the polymer film, wherein the pressure sensitive adhesive comprises a corrosion inhibiting additive selected from the group consisting of a material comprising approximately 20-50% by weight xylene and 50-80% by weight alkylammonium salt, and a material comprising approximately 90% by weight isopropanol and 10% by weight saturated carboxylated airlines; and
adhering the polymer film to the outer surface portion of the vehicle with the pressure sensitive adhesive in direct contact with the outer surface.

10. The method according to claim 9, wherein adhering the polymer film comprises heat curing the pressure sensitive adhesive.

11. A method of protecting an outer surface portion of a vehicle, the outer surface portion being formed of aluminum or carbon fiber composite and being free of a chromated primer coating, comprising:
providing an appliqué comprising:
a polymer film selected from the group consisting of polyurethane, polyethylene, polyester, or polyimide; and
a pressure sensitive adhesive backing the polymer film, wherein the pressure sensitive adhesive comprises a corrosion inhibiting additive selected from the group consisting of hexamine, dimethylethanolamine, sodium nitrite, cinnamaldehyde, nitrates, morpholine, a material comprising approximately 20-50% by weight xylene and 50-80% by weight alkylammonium salt, and a material comprising approximately 90% by weight isopropanol and 10% by weight saturated carhoxylated amines; and
adhering the applique to the outer surface portion of the vehicle with the pressure sensitive adhesive in direct contact with the outer surface portion.
